(19) United States
(12) Patent Application Publication
(10) Pub. No.: US 2009/0314748 A1
(43) Pub. Date: Dec. 24, 2009

(54) ULTRASONIC ASSISTED ELECTRODISCHARGE MACHINING

(75) Inventors: Balaji Rao, Glendale Park (SG); Kin Koeng Jek, Chestervale (SG); Mohammad Dzulkifli B. Mohyi Hapipi, Jurong West (SG)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: UNITED TECHNOLOGIES CORPORATION, Hartford, CT (US)

(21) Appl. No.: 12/497,938

(22) Filed: Jul. 6, 2009

(30) Foreign Application Priority Data
Jun. 21, 2008 (SG) 200805371-2

(51) Int. Cl. B23H 1/08

(52) U.S. Cl. 219/69.17; 219/69.2

(57) ABSTRACT

An apparatus for machining holes into a conductive workpiece includes a tank at least partially filled with a dielectric fluid, a fixture for holding the workpiece in the tank, an electro discharge machine, and an ultrasonic source. The electro discharge machine includes an electrode and a power supply connected to the electrode that produces machining pulses for electro discharge machining through the workpiece. The ultrasonic source includes an ultrasonic generator and a transducer, wherein the transducer is partially submerged in the fluid contained within the tank.

### BACKGROUND

This invention relates to the machining of components comprising an electrically conductive substrate. In particular the invention concerns a method and apparatus for machining through a metal substrate of a component of a gas turbine engine.

Electro discharge machining (EDM), also referred to as spark erosion and electro erosion, is well known as a method of drilling small holes through metal components such as gas turbine blades and guide vanes. The EDM process produces pulses of positive electrical potential that are applied to an electrode held close to the surface of a component where a hole is to be drilled while the component is negatively biased. Dielectric fluid is supplied to the gap between the component and the electrode and a succession of voltage pulses are applied to the electrode to produce the machining sparks that erode the base material of the component.

EDM enables a multiplicity of holes to be drilled simultaneously using a multi-wire head. The process is relatively cheap and accurate, and produces an acceptable finish in the superalloy metals normally used for gas turbine components. However, EDM is a rather time consuming process. High speed EDM processes have been developed and utilized, but increasing the speed of the EDM process typically results in a loss of accuracy and rougher finishes in the resultant component. The process works where strict tolerances for a finished part are not necessary. However, the current high speed processes do not work for tight or high tolerance components. Thus, there is a need for higher speed EDM processes that maintain accuracy and results in acceptable tolerances on the finished component.

### SUMMARY

An apparatus for machining holes into a conductive workpiece includes a tank at least partially filled with a dielectric fluid, a fixture for holding the workpiece in the tank, an electro discharge machine, and an ultrasonic source. The electro discharge machine includes an electrode and a power supply connected to the electrode that produces machining pulses for electro discharge machining through the workpiece. The ultrasonic source includes an ultrasonic generator and a transducer, wherein the transducer is partially submerged in the fluid contained within the tank.

In another embodiment, a method of creating a hole in a workpiece utilizes ultrasonic assisted electro discharge machining. A workpiece is secured within a bed of fluid in a tank. Ultrasonic waves within the bed of fluid in the tank are provided from an ultrasonic generator and transducer. Base material from the workpiece is removed by electro discharge machining.

In an alternate embodiment, a method of drilling a plurality of holes in a gas engine turbine component utilizes ultrasonic assisted electro discharge machining. The component is fixtured within a bed of fluid in an open top tank. An electro discharge machine is positioned over the component. The plurality of holes are simultaneously machined by utilizing the electro discharge machine containing a plurality of electrodes. Ultrasonic waves within the bed of fluid in the tank from an ultrasonic generator and transducer are provided to facilitate debris removal from the holes during the electro discharge machining process.

### BRIEF DESCRIPTION OF THE DRAWINGS

FIG. 1 is a schematic of an ultrasonic assisted electro discharge machine.

FIG. 2 is a perspective view of a portion of the ultrasonic assisted electro discharge machine.

### DETAILED DESCRIPTION

The present invention generally relates to electro discharge machining, commonly referred to as EDM, which is a process by which a spark jumps across a gap between positive and negative terminals. Heat produced by the spark melts away a small portion of the workpiece, typically in the form of minute hollow spheres. As voltage and amperage increase, the amount of material removed also increases. Thus, by controlling the current and other variables of the electric pulse in an environment that promotes spark generation, EDM removes material from a workpiece component.

EDM drilling is concerned with producing apertures, typically round holes, similar to apertures created by a standard drill with a bit. Although EDM is a relatively slow material removal process compared to conventional methods, EDM is utilized when the materials or processing methods are difficult. This is especially true for superalloys used in the aircraft industry. Superalloys are difficult to machine or drill by conventional methods due to the hardness of the material.

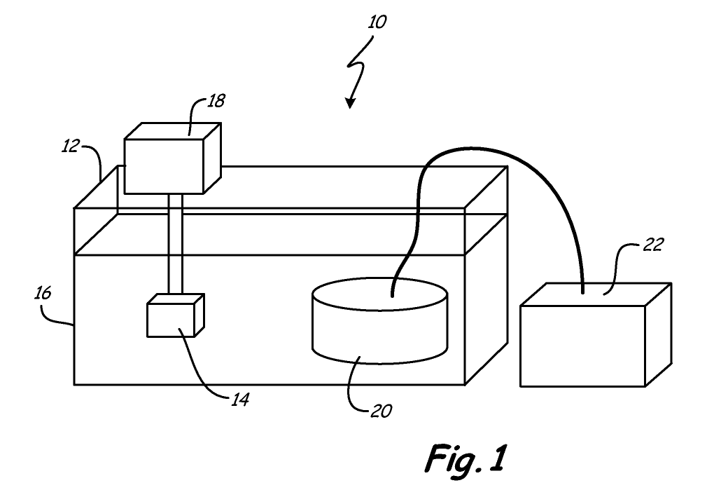

FIG. 1 is a schematic illustrating a high speed EDM machine 10 that incorporates ultrasonic vibrations, hereinafter referred to as ultrasonic electro discharge machining, or USEDM. Tank 12 holds workpiece 14 in a bed of fluid 16. EDM head 18 is positioned over workpiece 14. Ultrasonic transducer 20 is situated within the fluid bed, and connected to generator 22. Workpiece 14 is the component that is to be machined, and in one embodiment is a turbine part such as a blade or vane.

Tank 12 collects and holds fluid 16, which is a dielectric medium such as deionized water. In an alternate embodiment, fluid 16 is a low viscosity mineral oil or similar substance, and may contain additives that lower the conductivity of the base substance. Fluid 16 provides an insulating medium about workpiece 14 until desired spark conditions are produced, and then acts a conducting medium through which the spark can travel. Fluid 16 also acts to flush disintegrated particles created by the spark away from the work area, and cools the interacting electrode and workpiece. In one embodiment, fluid 16 flows across the part through the use of a circulating system (not illustrated), which includes a discharge or suction port, a pump, and an inlet or pressure port. Fluid 16 may contain additional additives to lubricate the pump and other circulatory systems components.

Tank 12 is sized to hold workpiece 14 as well as any associated tooling for positioning workpiece 14, and transducer 20. Tank 12 is oversized to allow workpiece 12 to be entirely submerged without allowing fluid 16 to spill over the edges of tank 12. Tank 12 may be of any geometry provided it meets the aforementioned limitations. In the embodiment illustrated, tank 12 is generally rectangular shaped. Tank 12 is constructed from plastics, polymers, fiberglass, or similar non-conducting materials, or may be fabricated from a dielectrically lined metal or alloy.

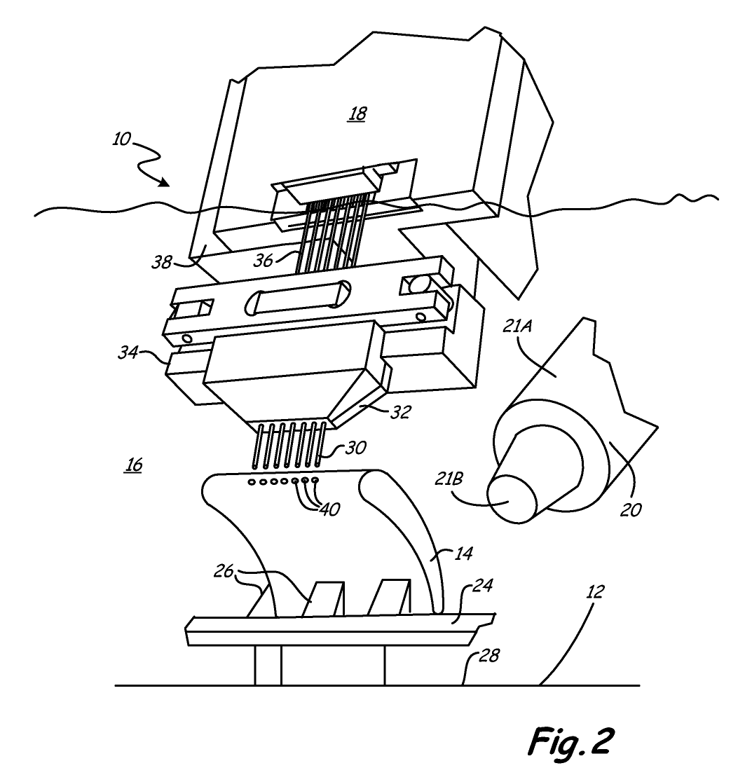

EDM head 18 is further detailed in FIG. 2, which shows additional detail of the USEDM machine. USEDM 10 has tank 12 with fluid 16 surrounding submerged workpiece 14. Workpiece 14 is secured with a tooling fixture that has a base portion 24 and clamps 26. Base portion 24 is attached to bottom surface 28 of tank 12. Clamps 26 are any commonly know devices that secure workpiece 14 in a desired location. Base portion 24 and clamps 26 may be designed for each specific application of the USEDM machine, i.e., designed for each component of a turbine to be worked on.

EDM head 18 is mounted above workpiece 14, and has electrodes 30, nose guide 32 attached to tooling mount 34, electrode guides 36, and EDM control 38. Electrodes 30 are either hollow or solid core rods constructed from any electrically conductive material, including tungsten, copper tungsten carbide, copper graphite alloy, graphite, tantalum tungsten alloy, silver tantalum alloy, or other alloys. Electrodes 30 are a consumable, and wear in a ratio generally around 100 to 1 of workpiece material removed to electrode material removed. The number of electrodes 30 will vary depending on the number of holes to be drilled on the part with each electrode capable of drilling a corresponding hole.

Nose guide 32 acts to position electrodes 30 with respect to workpiece 14. Nose guide 32 is constructed from common tooling materials and may be lined with corundum or ceramic coating. Nose guide 32 may also provide insulation to electrodes 30. Nose guide 32 also reduces the amount of play in each electrode, thus keeping the amount of overcut and other defects to a minimum. Although nose guide 32 is manufactured to keep close tolerance by electrodes, a certain amount of clearance is required to allow rotation and/or vibration of electrodes 30.

Tooling mount 34 connects nose guide 32 to EDM control 38, and is constructed as is well known in the art. Similarly, electrode guides 36 connect the electrodes to the EDM control 38. Electrode guides 36 are tubes that approximately align electrodes 30, which are then more precisely aligned by nose guide 32.

EDM control 38 is the operational center of the EDM head 18. EDM control 38 has a power source that is operated to cause a charge to build up on electrodes 30, which when sufficient causes an electrical current to jump the spark gap. Charge buildup and discharge is achieved by providing a suitable dielectric fluid 16 between electrode 30 and workpiece 14, such that material is removed from workpiece 14 by a sparking discharge action. In one embodiment, EDM control 38 contains a servo motor (not shown) that maintains the spark gap distance through control signals received from a microprocessor based controller (not shown). The controller will sense the gap voltage, determine the offset from a preset value, and send a control signal to the servo motor to advance or retract. EDM control 38 may also have a multi-axis positioner that controls the placement of tooling mount 34 with respect to workpiece 14.

Ultrasonic transducer 20 is connected to ultrasonic generator 22 (see FIG. 1). Ultrasonic transducer 20 is electrically energized by the generator 22, which has means for controlling both the frequency and amplitude of ultrasonic vibration. Ultrasonic transducer 20 has a converter 21A at a first end, with a sonotrode 21B connected thereto. Optionally, transducer 20 may have a booster between the converter and sonotrode. The converter is energized by generator 22, which passes the energy along to be emitted as ultrasonic waves through the sonotrode. Ultrasonic transducer 20 is placed to be adjacent workpiece 14, so as to direct the ultrasonic vibrations towards workpiece 14 with maximum effect. At least a portion of the sonotrode of the ultrasonic transducer is submerged in fluid 16.

EDM is a process in which an electrically conductive metal workpiece is shaped by removing material through melting or vaporization by electrical sparks and arcs. The spark discharge and transient arc are produced by applying controlled pulsed direct current between the workpiece (typically anodic or positively charged) and the tool or electrode (typically the cathode or negatively charged). The end of the electrode and the workpiece are separated by a spark gap generally from about 0.01 millimeters to about 0.50 millimeters, and are immersed in or flooded by a dielectric fluid. The DC voltage enables a spark discharge charge or transient arc to pass between the tool and the workpiece. Each spark and/or arc produces enough heat to melt or vaporize a small quantity of the workpiece, thereby leaving a tiny pit or crater in the work surface. The cutting pattern of the electrode is usually computer numerically controlled (CNC) whereby servomotors control the relative positions of the electrode and workpiece. The servomotors are controlled using relatively complex and often proprietary control algorithms to control the spark discharge and control gap between the tool and workpiece. By immersing the electrode and the workpiece in the dielectric fluid, a plasma channel can be established between the tool and workpiece to initiate the spark discharge. The dielectric fluid also keeps the machined area cooled and removes the machining debris. An EDM apparatus typically includes one or more electrodes for conducting electrical discharges between the tool and the workpiece.

Current EDM processes are relatively slow processes, especially when several distinct features need to be machined into a workpiece with very tight tolerances. This is particularly so in the aircraft engine industry where electrical discharge machining is widely used for machining various features into aircraft engine parts. For example, turbine airfoils may contain numerous cooling holes of various geometries, sizes, locations, and arrangements. EDM can be used to drill several holes at once, but the process is extremely time consuming.

However, utilizing ultrasonic waves with EDM results in a process that is quicker that EDM alone. Ultrasonic waves are created by submerging at least a portion of ultrasonic transducer 20 into the bed of fluid 16 within tank 12 while the submerged workpiece 14 is being drilled. The resultant waves produced by ultrasonic transducer 20 clear the debris created by EDM, thereby making the USEDM process much faster and more effective than standard EDM processes.

Many factors can be modified to create an USEDM optimized process. The orientation of the transducer can be set to assure maximum results from the ultrasonic waves produced. Similarly, the distance of the transducer from the part can be adjusted, which will affect the effects of the ultrasonic waves. The power of the transducer can be adjusted to obtain the desired effect of the ultrasonic waves created. Current and arc parameters of the EDM portion of the process can be altered as necessary to interact with the ultrasonic waves. Additionally, all of the above can be adjusted together to obtain maximum benefit.

The USEDM process may also benefit from other adjustments to the process. The electrodes may be either vibrated or rotated, and fabrication of the electrode may be dependent upon which motion is chosen. A hollow electrode which doubles as a horn to concentrate the ultrasonic waves may be designed for the process. Finally, the source of the ultrasonic waves may be altered. For instance, utilizing the tank itself or another external ultrasonic wave generator may be possible.

The current system does not utilize what is conventionally referred to as ultrasonic machining. In ultrasonic machining, the transducer converts electrical energy into mechanical motion that causes a low amplitude vibration. A tool is attached to the ultrasonic transducer and fed towards the workpiece under controlled pressure with a constant flow of abrasive slurry between the tool and workpiece. The vibration, generally in the range of 20,000 cycles per second, forces solids of the slurry against the workpiece and results in microscopic chipping away of the workpiece base material. In the current system, EDM does the actual cutting of the base material of the workpiece, while the ultrasonic waves in the dielectric fluid bed act to disrupt and remove debris from the work area. No slurry is required, and the tooling is not connected to the transducer.

Four trials using USEDM were run on airfoils all having the same part number, and compared to a control part made using the standard EDM process. Trailing edge holes were drilled into all five parts. The EDM machine contained the same number of electrodes for all trials. The parts were all submerged within a fluid contained within a tank. The standard EDM process took approximately 40 minutes to complete at the specified sparking parameter (arc, voltage, and amperage) settings for the part. The part was measured, and all holes were within acceptable tolerances. Acceptable tolerance for the holes is in the range of 0.533 mm to 0.686 mm.

Trial 1

A portable ultrasonic generator was used. The transducer was placed to have the sonotrode touching the base of the fixture of the part. The converter was fixed to the tank edge. The feed rate was increased. The process took over 35 minutes to complete. It was determined that fixing the first end of the transducer reduced the amplitude of the ultrasonic waves. This corresponded to a reduced flushing or cavitation effect. The part was measured, and all holes were within acceptable tolerances.

Trial 2

The same portable ultrasonic generator was used. The converter was fixed to the tank wall. The sonotrode was partially submerged into the fluid contained in the tank, but was not constrained as the in the first trial. The transducer was held free floating in the dielectric fluid. With this implementation, the time for finishing the part was reduced to 25 minutes. The part was measured, and all holes were within acceptable tolerances.

Trial 3

The same portable ultrasonic generator was used. A special mount was utilized to secure the transducer. The sonotrode was partially submerged into the fluid contained in the tank. The entire transducer was tilted to enable the waves to direct towards the cooling holes being drilled. The settings for response and feed were increased slightly. The time to finish the part was 20 minutes and 30 seconds. The part was measured, and all holes were within acceptable tolerances. Twenty-nine of the holes were measured at 0.559 mm, and three were measured at 0.584 mm. This was a reduction in variation among holes from the control part. The part was cut up to obtain magnified images of the holes. All holes were acceptable, and did not contain excessive pitting or debris. Measures observed for surface irregularity, spark out, remelt layer cracks, base metal cracks, and recast defects all were acceptable. This was the most aggressive test, and all holes met specification and tolerances.

Trial 4

The same portable ultrasonic generator was used. The converter was again mounted with the special mount to obtain an angle to enable the waves to direct towards the cooling holes being drilled. The sonotrode was partially submerged into the fluid contained in the tank. The settings for response and feed were decreased slightly. The time to finish the part was 21 minutes and 4 seconds. The part was measured, and all holes were within acceptable tolerances. Thirty of the holes were measured at 0.533 mm, and two were measured at 0.559 mm. This again was a reduction in variation among holes from the control part.

Thus, a method of drilling holes in a component workpiece can be achieved by USEDM. The workpiece is secured within a bed of fluid in an open top tank, and ultrasonic waves within the bed of fluid in the tank are provided from an ultrasonic generator and transducer. Base material from the workpiece is removed by electro discharge machining. The ultrasonic waves are directed towards the area of the workpiece being machined, and act to flush the machined area to prevent molten material from the process from reattaching. This cuts down on the time required for the machining process as the EDM is not reworking material.

Although the present invention has been described with reference to preferred embodiments, workers skilled in the art will recognize that changes may be made in form and detail without departing from the spirit and scope of the invention.

1. An apparatus for machining holes into a conductive workpiece, the apparatus comprising:
a tank at least partially filled with a dielectric fluid;
a fixture for holding the workpiece in the tank;
an electro discharge machine comprising an electrode, a power supply connected to the electrode that produces machining pulses for electro discharge machining through the workpiece; and
an ultrasonic source comprising an ultrasonic generator and a transducer, wherein the transducer is partially submerged in the dielectric fluid contained within the tank.

2. The apparatus of claim 1 wherein the workpiece is submerged in the dielectric fluid within the tank.

3. The apparatus of claim 1 wherein the electro discharge machine further comprises a plurality of electrodes secured to a nose guide.

4. The apparatus of claim 3 wherein the nose guide is connected to a multi-axis positioner that controls the placement of the nose guide with respect to the workpiece.

5. The apparatus of claim 1 wherein the transducer is mounted to the tank adjacent the workpiece.

6. The apparatus of claim 5 wherein the transducer is mounted at an angle that maximizes the amplitude of the ultrasonic waves with respect to the hole being machined by the electro discharge machine.

7. The apparatus of claim 1 wherein the workpiece is a component of a gas turbine engine.

8. A method of creating a hole in a workpiece utilizing ultrasonic assisted electro discharge machining, the method comprising:
securing a workpiece within a bed of fluid in a tank;
providing ultrasonic waves within the bed of fluid in the tank from an ultrasonic generator and transducer; and
removing material from the workpiece by electro discharge machining.

9. The method of claim 8 wherein removing material comprises drilling a plurality of holes in the workpiece.

10. The method of claim 8 further comprising:
angling the transducer with respect to the workpiece.

11. The method of claim 8 further comprising:
adjusting the distance of an end of the transducer with respect to the workpiece.

12. The method of claim 8 further comprising:
adjusting the power of the transducer to obtain the desired effect of the ultrasonic waves within the bed of fluid.

13. The method of claim 8 wherein the bed of fluid comprises a dielectric material.

14. The method of claim 8 wherein the workpiece is an airfoil of a gas turbine engine.

15. The method of claim 8 further comprising:
mounting the transducer to the tank so that at least a first end of the transducer is submerged in the bed of fluid.

16. The method of claim 15 wherein the first end of the transducer is adjacent the workpiece.

17. A method of drilling a plurality of holes in a gas engine turbine component, the method comprising:
fixturing the component within a bed of fluid in a tank;
positioning an electro discharge machine over the component;
machining the plurality of holes simultaneously by utilizing the electro discharge machine containing a plurality of electrodes; and
providing ultrasonic waves within the bed of fluid in the tank from an ultrasonic generator and transducer to facilitate debris removal from the holes during the electro discharge machining process.

18. The method of claim 17 wherein the component is an airfoil.

19. The method of claim 17 further comprising:
positioning the transducer within the bed of fluid such that a first end of the transducer is adjacent the component and directs the ultrasonic waves towards the plurality of holes being machined.

20. The method of claim 17 further comprising:
adjusting the power of the transducer to enhance a material removal effect on the component.
